(19) United States
(12) Patent Application Publication
(10) Pub. No.: US 2021/0237497 A1
(43) Pub. Date: Aug. 5, 2021

(54) TRANSFER MEDIA

(71) Applicant: Hewlett-Packard Development Company, L.P., Spring, TX (US)

(72) Inventors: Raffaella Fior, San Diego, CA (US); John GARDNER, San Diego, CA (US); Dheya M. ALFEKRI, San Diego, CA (US)

(73) Assignee: Hewlett-Packard Development Company, L.P., Spring, TX (US)

(21) Appl. No.: 17/048,841

(22) PCT Filed: Apr. 30, 2018
(86) PCT No.: PCT/US2018/030193

§ 371 Date: Oct. 19, 2020

(51) Int. Cl. B41M 3/12; B41F 16/02; B44C 1/17

(52) U.S. Cl. CPC B41M 3/12; B44C 1/1712; B41F 16/02

(57) ABSTRACT

A transfer medium can include a transfer film, including an adhesion layer and a protection layer attached to the adhesion layer, wherein the transfer film is transparent or translucent. The transfer medium can also include a removable liner, including a base layer and silicone release layer. A deformable layer can be positioned between the base layer and the silicone release layer. An inner surface of the silicone release layer can be adhered to an outer surface of the protection layer.

### BACKGROUND

Inkjet printing has become a popular way of recording images on various media. Some of the reasons include low printer noise, variable content recording, capability of high speed recording, and multi-color recording. These advantages can be obtained at a relatively low price to consumers. As the popularity of inkjet printing increases, the types of use also increase providing demand for new ink compositions and types of print media applications. In one example, textile printing can have various applications including the creation of signs, banners, artwork, apparel, wall coverings, window coverings, upholstery, pillows, blankets, flags, tote bags, clothing such as T-shirts, etc.

### BRIEF DESCRIPTION OF DRAWINGS

FIG. 1 schematically depicts an example transfer medium in accordance with the present disclosure;

FIG. 2 is a flowchart that provides an example method of transferring an image to a fabric substrate in accordance with the present disclosure;

FIG. 3A depicts various components of an example fabric imaging system in accordance with the present disclosure;

FIG. 3B depicts various components of an example fabric imaging system in accordance with the present disclosure;

FIG. 4 schematically depicts an alternative example transfer medium in accordance with the present disclosure; and

FIGS. 5A-5C depict an example transfer medium with an ink composition image applied thereto, as well as the application of a transfer film from the transfer medium to a fabric substrate in accordance with the present disclosure.

### DETAILED DESCRIPTION

The present technology relates to transfer media, including transfer media for generating images on fabric, for example. In accordance with this, a transfer medium can include a transfer film and a removable liner. The transfer film can include an adhesion layer and a protection layer attached to the adhesion layer. The transfer film can be transparent or translucent. The removable liner can include a base layer and silicone release layer. A deformable layer can be positioned between the base layer and the silicone release layer. The inner surface of the silicone release layer can be adhered to an outer surface of the protection layer. In one example, the adhesion layer can have a thickness from 2.5 μm to 50 μm, and the durability coating layer can have a thickness from 1 μm to 25 μm. The durability coating layer can be thinner than the adhesion layer. The transfer film can also include a composited film interface along an inner surface of the protection layer and an outer surface of the adhesion layer the film interface. The term “composited interface” defines the region where the outer surface of the adhesion layer is fused beyond the inner surface of the protection layer, but not through the protection layer. In this region, there can be a polymer admixture of the two layers. If present, the composited film interface can have a thickness less than a thickness of the durability coating layer. The thickness ranges for the adhesion layer and the durability layer can exclude the thickness of the composited interface, if present. The adhesion layer can include a polymer, copolymer, or blend thereof having a surface energy from 35 dyne/cm to 50 dyne/cm. The durable coating layer can include a polymer, copolymer, or blend thereof having a Rockwell hardness from 50 to 110 (HR-A scale). In one example, the transfer medium can include an ink composition layer on an inner surface of adhesion layer. The base layer can include paper in one example, and the deformable layer can be coated on both sides of the paper. The deformable layer has a softening point from 120° C. to 200° C., and for example, can include polyethylene, polypropylene, polyurethane, a copolymer thereof, or a blend thereof. The silicone release layer can be a polydimethylsiloxane, for example.

In another example, a method of transferring an image to a fabric substrate can include contacting the fabric substrate with an imaged inner surface of a transfer medium. The transfer medium can include a transfer film including an adhesion layer and a protection layer attached to the adhesion layer. The transfer film can be transparent or translucent. The transfer medium can also include a removable liner which includes a base layer and silicone release layer. A deformable layer can also be present that is positioned between the base layer and the silicone release layer. An inner surface of the silicone release layer can be adhered to an outer surface of the protection layer. The method can further include applying heat and pressure to the transfer medium while the imaged inner surface is in contact with the fabric substrate to fuse the transfer film to the fabric substrate, and separating the removable liner from the transfer film after fusing. In one example, fusing can include applying heat at from 175° C. to 205° C. and pressure at from 20 psi to 90 psi for 10 seconds to 120 seconds. In another example, the deformable layer can have a softening point ranging from a maximum temperature applied to the transfer medium during fusing to 75° C. less than the maximum temperature. Fusing can cause the deformable layer to soften or melt so that the base layer and the deformable layer forces the transfer film into voids of the fabric substrate using the silicone release layer as an intermediate to prevent the deformable layer from contacting the transfer film. In another example, the imaged inner surface can be prepared by inkjetting a reverse image onto the inner surface of the adhesion layer.

In another example, a fabric imaging system can include a transfer medium. The transfer medium can include a transfer film including an adhesion layer and a protection layer attached to the adhesion layer. The transfer film can be transparent or translucent, for example. The transfer medium can also include a removable liner which includes a base layer and silicone release layer with a deformable layer positioned between the base layer and the silicone release layer. An inner surface of the silicone release layer can be adhered to an outer surface of the protection layer. The system can also include a fusing press to apply from 175° C. to 205° C. heat and from 20 psi to 90 psi pressure to the transfer medium when an inner surface of the adhesion layer is contacted with a fabric substrate. In one example, the system can further include an inkjet printer to apply a reverse image to the inner surface of the adhesion layer.

As a note, with respect to the transfer media, methods of transferring images to fabric substrates, and textile printing systems described herein, specific descriptions can be considered applicable to other examples whether or not they are explicitly discussed in the context of that example. Thus, for example, in discussing a polymer related to a transfer film of a transfer medium, such disclosure is also relevant to and directly supported in context of the methods of textile printing and textile printing systems, and vice versa.

For clarity, the term “transfer medium” or “transfer media” refers to a multi-layered structure that includes five layers, and those five layers are further defined within the context of two multi-layered sub-structures that are separable or releasably attached to one another. One multi-layered sub-structure is referred to as a “transfer film,” which includes two layers, namely the adhesion layer and the durability layer. The other multi-layered sub-structure of the transfer medium is referred to as a “removable liner,” which includes a base layer, a deformable layer, and a silicone release layer.

In further detail, the various layers can be defined as having an “inner” surface and an “outer” surface. It is understood that these terms are defined relative to the fabric substrate. Thus, an “inner” surface is the surface closer or proximal to the fabric substrate as applied and the “outer” surface is the surface further or distal relative to the fabric substrate.

For further clarity, the terms “reverse” or “mirror” when referring to an image or printed image relates to the image as applied to the inner surface of the adhesion layer. The image is printed in reverse or as a mirror image because the printed image is not to be viewed (on the fabric) as printed on the inner surface of the adhesion layer because the inner surface is ultimately applied to the fabric substrate. In other words, the printed image to be viewed on the fabric is not from the perspective of the inner surface of the adhesion layer, but rather through the image receiving layer (and through the durability layer) from the perspective of the outer surfaces thereof of the transfer film after application to the fabric and removal of the removable liner.

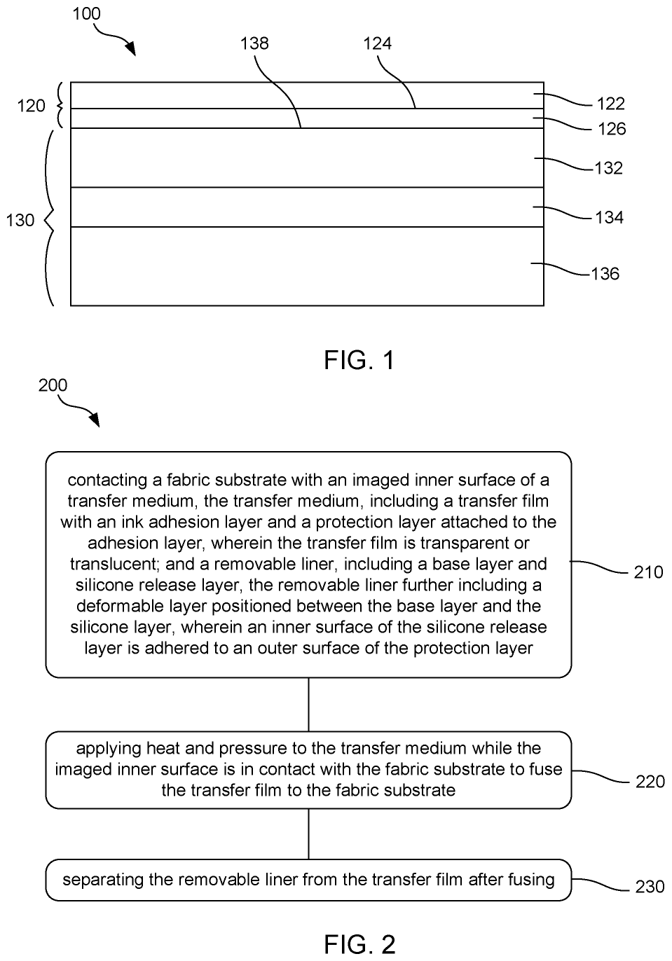

With this in mind, in reference to FIG. 1 by way of example, a transfer medium 100 can include a transfer film 120 and a removable liner 130. The transfer film can include two layers, namely an adhesion layer 122 and a protection layer 122. In one example, the adhesion layer and the protection layer can be fused together along a film interface 124 by melt co-extrusion onto the removable liner. In further detail, the removable liner can also include multiple layers, including a base layer 136, a deformable layer 134, and a silicone release layer 132. These various layers can be used together to transfer a printed image to a fabric substrate along with the transfer film, followed by separation (and discarding in some examples) of the removable liner from the transfer film at a release interface 138.

When referring to the various polymers herein, melting temperature and Melt-mass Flow Rate (MFR) of the various polymers used to prepare, e.g., co-extrude, the transfer film layers onto the removable liner can be considered. For example, MFRs can be selected that are useable for co-extrusion of the two transfer film layers, e.g., adhesion layer and durability layer. On the other hand, when considering application of a printed transfer film to fabric, melt flow rate, melting temperature, and/or softening point can be considered. There may be polymer layers that have a melting point that is lower than the application temperature (of the transfer film of the fabric substrate), and there may be polymer layers that have a softening point that is lower than the application temperature with a melting higher than the application temperature, for example.

“Melting temperature” or “melting point” refers to the temperature at which a polymer transitions from a solid phase to a liquid phase. As this process can occur over a temperature range, the initial phase change temperature and the completed phase change temperature can be determined, and then an average value from the range end points can be used to determine melting point.

“Melt-mass Flow Rate” or “MFR” can be determined using ASTM D1238 or ISO 1133 procedures. More specifically, MFR can be measured by determining the amount of material (in grams) of material that can be pushed through a device in 10 minutes at 230° C. under 2.16 kg pressure. This value can be used to evaluate materials for co-extruding as the transfer film onto the removable liner, for example. MFR can be determined above the melting point of the polymer, for example. For polymers having melting points that would not provide reliable data at 230° C. under 2.16 kg pressure, other accepted values can be used that would be more appropriate for those specific polymers.

“Softening Point” refers to the Vicat softening temperature (or temperature range in some instances) of a polymer and can be obtained by the manufacturer in many instances. The softening point can also be independently measured using a Vicat hardness tester in accordance with ASTM D1525. The measurement is carried out using a flat-ended needle with a 1 mm² circular cross section, and the softening point is determined as the temperature at which the polymer can be penetrated by 1 mm under the specified loads. Two different acceptable loads e.g., 10 N (+/−0.2 N) or 50 N (+/−1.0 N), are provided with this test because the test is standardized for a wide variety materials that responds differently to different types of applied loads. Either load can be used to establish a softening point, or both loads when values are consistent with expected softening points can be used to establish a reasonable softening point range in accordance with the present disclosure.

In further detail, in addition to MFR, softening point, and melting temperature of the polymers per se, it is notable that adding pressure to the equation, operational temperatures can be reduced, e.g., softening and/or melting can occur at lower temperatures due to the combination of the heat and pressure. Thus, at lower temperatures, transfer film material can be pushed into pores of the fabric substrate with the assistance of the various layers in the removable liner, some of which are also polymers that can soften or melt at application temperatures. In other words, during application of the transfer film to a fabric substrate, polymer or copolymer softening or melting can occur in the various polymeric layers of the transfer medium, including the adhesion layer, the durability layer, the silicone release layer, and/or the deformable layer. Whether layers are softened or melted at application temperature, depending on the design of the transfer medium as a whole, the transfer process can be carried out to achieve good print quality, durability, good hand, and/or drape properties.

FIG. 2 provides a flow chart of a method 200 of transferring an image to a fabric substrate, which can include contacting 210 the fabric substrate with an imaged inner surface of a transfer medium. The transfer medium can include a transfer film including an adhesion layer and a protection layer attached to the adhesion layer. The transfer film can be transparent or translucent. The transfer medium can also include a removable liner which includes a base layer and silicone release layer, and having a deformable layer positioned between the base layer and the silicone release layer. An inner surface of the silicone release layer can be adhered to an outer surface of the protection layer. The method can further include applying 220 heat and pressure to the transfer medium while the imaged inner surface is in contact with the fabric substrate to fuse the transfer film to the fabric substrate, and separating 230 the removable liner from the transfer film after fusing.

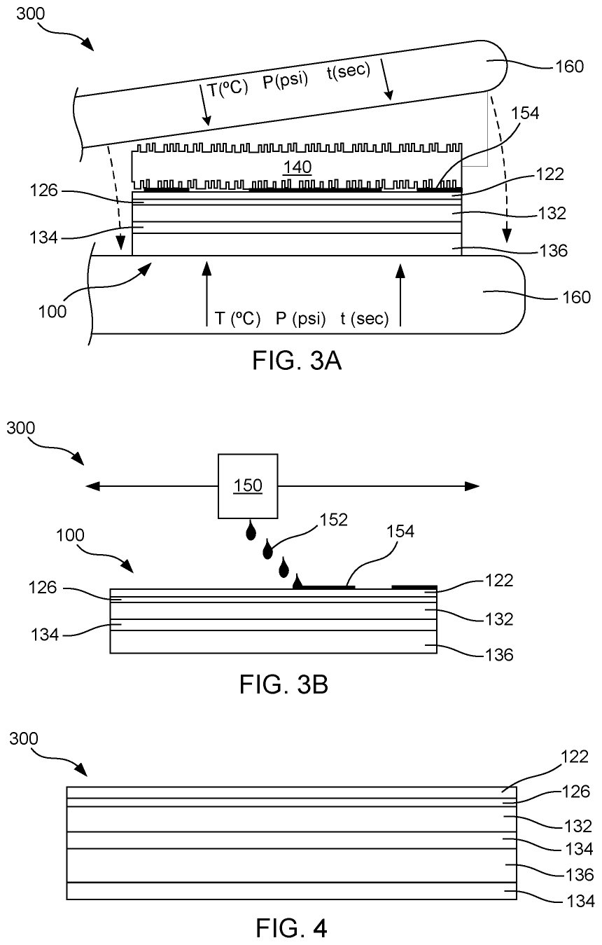

FIGS. 3A and 3B depict various components of example fabric imaging systems. More specifically, in one example, a fabric imaging system 300 can include a transfer medium 100 having a transfer film (shown in FIG. 1 at 120) and an adhesion layer 122 and a protection layer 126 and a removable liner (shown in FIG. 1 at 130) including a base layer 136 and silicone release layer 132 having a deformable layer therebetween 134. The system can also include a fusing press 160 (shown in FIG. 3A) to apply heat and pressure for a time period, e.g., T=175° C. to 205° C.; P=20 psi to 90 psi; and t=10 seconds to 120 seconds, to the transfer medium with a fabric substrate 140 in contact therewith. Other temperature ranges, pressure ranges, and/or time ranges can be used, depending on the polymers selected for use in the various layers. The fusing press can be a clamshell press, for example, as shown. In further detail, the fusing press can be used to heat fuse an inner surface of the transfer medium (or more specifically an inner surface of the adhesion layer) with the fabric substrate. In further detail, as shown more specifically in FIG. 3B, a fabric printing system can further include a printer 150 to apply a printed image 154 to the inner surface of the adhesion layer, prior to fusing with the fusing press. The printed image can be applied using inkjet technology by ejecting ink composition droplets 152 onto the adhesion layer.

FIG. 4 is provided primarily to show that the deformable layer 134 can be applied on both sides of the base layer 136. The other layers can be similar to that shown in FIG. 1, namely an adhesion layer 122 and a durability layer 126 can be co-extruded to collectively form a transfer film. Furthermore, the silicone release layer 132 can also be present. Other features and details common to these layers are also applicable to this example, as described elsewhere herein.

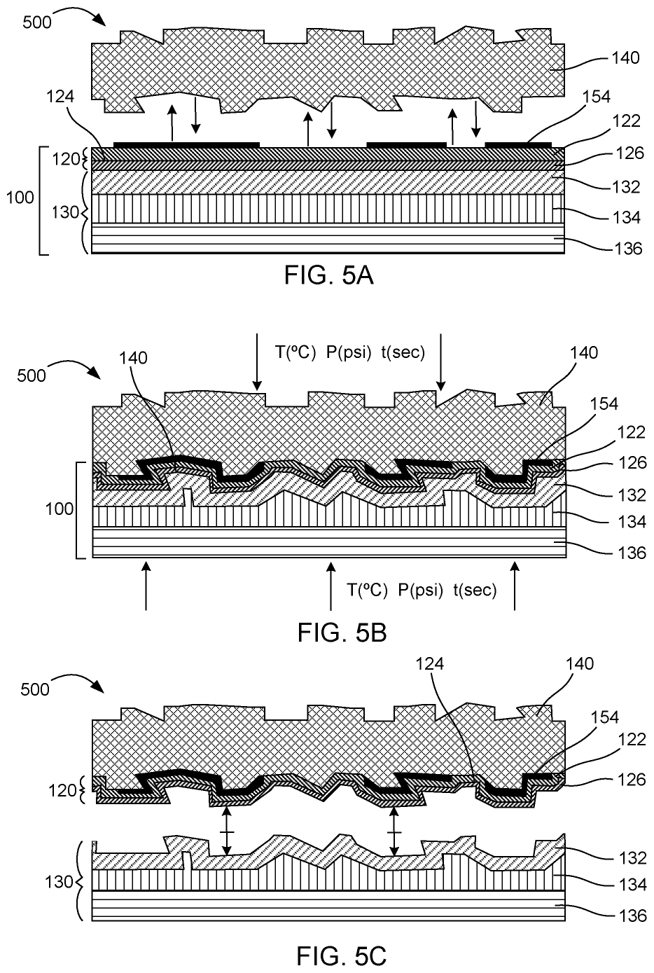

In the example shown in FIGS. 5A-5C, additional details regarding materials, thicknesses, material properties, operations, systems, methods, transfer media, and the like, are shown generally at 500. In this example, similar to that shown and described in FIGS. 1-4, the transfer medium 100 can include a multi-layered transfer film 120 with an adhesion layer 122 and a durability layer 126 and can further include a multilayered removable liner 130 with a base layer 136, a deformable layer 134, and a silicone release layer 132. These various layers are shown at various sequential processing stages, with FIG. 5A showing an imaged transfer medium prior to fusion with the fabric substrate 140, FIG. 5B showing after fusion but before separation of the removable liner from the transfer film, and FIG. 5C showing the imaged fabric (collectively shown at 122 and 154, and more specifically at 122, 154, 122, and 126) after fusion and after separation of the removable liner. Notably, in this example, the transfer film and image are forced into pores of the fabric. Furthermore, even though the silicone release layer is removed, it can retain an imprint from being heated and being pushed by force into the transfer film by the deformable layer and the base layer. In other words, the embossed appearance of the silicone release layer provides evidence that the removable release liner had the function of pushing the transfer film into pores of the fabric substrate. This embossing effect can provide a printed image on the fabric that can have a similar level of (low) gloss that has a desirable appearance because the imaged transfer film remaining on the fabric after the transfer tends to blend visually with the more matte appearance of many fabrics, such as those fabrics often used for T-shirts or other similar apparel, e.g., sweatshirts, hoodies, pants, shorts, sports apparel, hats, gloves, socks, shoes, undergarments, etc.

In further detail regarding the individual layers of the transfer medium 100, it is noted that the adhesion layer 122 can receive a printed image 154 thereon, such as an image generated using an ink composition or a latex inkjet ink composition. In one example, the printed image can be applied as a reverse or mirror image on an inner surface of adhesion layer, as the printed image can be viewable through an outer surface of transfer film as a whole rather than directly on the surface to which it is applied. As mentioned, and further clarified here, the terms “inner” and “outer” describe individual layer surfaces, transfer film surfaces, or removable liner surfaces relative to their position once applied to the fabric substrate 140. Thus, for example, a surface of a layer that is more proximal to the fabric substrate can be referred to as an “inner” surface and a surface of the same layer more distal to the fabric substrate can be referred to as an “outer” surface, even if it is not an outermost surface relative to other more distally positioned layers.

The protection layer 126, on the other hand, can provide protection to printed image 154 when the transfer film 120 is applied to the fabric substrate 140. Both layers of the transfer film can be translucent or transparent so that the printed image can be viewed therethrough. In one example, the transfer film layers can be co-extruded onto the removable liner under heat, and the two layers can be fused together at a film interface 124. In one example, these two layers can be fused but not comingled or composited along the interface, e.g., thin enough to not be detectable or verifiable. In another example, the fusion can cause the two layers of the transfer film to form a composited interface where the materials of the two layers blend together along the interface at a thickness (the thickness or lack thereof can alternatively be represented by the line shown at film interface 124). In another example, the adhesion layer can have a thickness from 2.5 μm to 50 μm, from 5 μm to 45 μm, from 7.5 μm to 40 μm, or from 10 μm to 30 μm. In another example, the durability coating layer can have a thickness from 1 μm to 25 μm, from 2.5 μm to 20 μm, or from 5 μm to 15 μm for example. Typically, the adhesion layer can be thicker than the durability layer. If there is a composited interface layer with a detectable or verifiable thickness, that portion of the thickness is not considered in the context of individual layer thickness ranges provided. Typically, if there is a composited interface where the two layers are fused together, it can be thinner than either layer individually, the thinner of which can typically be the durability layer when trying to retain fabric drape and/or hand properties to the extent desired for a given application, e.g., slight reduction in drape and/or hand properties where the transfer film has been applied compared to areas where no transfer film has been applied.

As an ink composition, for example, can be printed on the adhesion layer 122 of the transfer film 120, and may not be directly printed on the fabric substrate 140, image quality of the printed image 154 can be controlled as a function of the transfer film properties rather than the fabric properties. Furthermore, as the transfer film remains on the fabric substrate over the image, the printed image remains on the transfer film even after application to the fabric substrate. As a result, the quality of the image can be largely retained because there is not a true transfer of the printed image per se from the transfer film to the fabric, but rather application of the entire transfer film with the image printed thereon to the fabric substrate. Thus, the printed image becomes applied ultimately to both the transfer film, e.g., the adhesion layer, and the fabric substrate.

In further detail regarding the transfer film 120 of the transfer medium 100, the adhesion layer 122 can be defined as the layer to which the image 154 is printed, such as a latex ink-generated image, or more specifically a latex inkjet ink-generated image in some examples. Thus, the inner surface of the adhesion layer can receive an image, typically a reverse image or mirror image, which is applied to the fabric substrate 140 after imaging. In one example, the adhesion layer can include, for example, a polymer or copolymer with a polarity suitable for receiving an aqueous ink composition.

Polymers without polar components, or where the polar components are null, are not considered to be polar. In one example, the polar components included in the polymer or copolymer can be from 4 dyne/cm to 12 dyne/cm, or from 6 dyne/cm to 10 dyne/cm. In further detail, surface energy provided by the polymer or copolymer at a surface thereof can also be used to evaluate or approximate polarity as well, which can provide details regarding the ability of a polymer surface, e.g., the adhesion layer, to receive and become adhered to latex ink compositions. Surface energies can be, for example, from 35 dyne/cm to 50 dyne/cm, or from 40 dyne/cm to 50 dyne/cm.

“Surface energy” can be evaluated and quantified using the VanOss-Good-Choudhury method, which examines surface free energy (SEF), calculating results from contact angle measurements, such as at the surface of the adhesion layer. In accordance with the present disclosure, surface energy can be used as indirect method for confirming the presence of surface polar groups. Essentially, to measure surface energy of a polymer layer, contact angle measurement (goniometry) of a liquid applied to the surface of the polymer can be used. For example, Young's equation (γ=γ_{sI}+y_{Iv} cos θ; where θ is the contact angle, γ is the solid surface free energy, γ_{sI} is the solid/liquid interfacial free energy, and γ_{Iv} is the liquid surface free energy) can be used to calculate the surface energy from measured contact angle using a dyne solution or dyne fluids, e.g., water, methylene iodide, and glycerol, with known surface tension properties in a controlled atmosphere. In other words, by using dyne fluid(s) (liquid) and atmosphere (gas) with known free energies, and by measuring the contact angle (acute angle between the flat surface and the relative angle at the base of liquid where it contacts the flat surface) of the liquid bead on the polymer surface, these three pieces of data can be used with Young's equation to determine the surface energy of the polymer surface. In one example, the device used for taking a contact angle measurement can be an FTA200HP or an FTA200, from First Ten Angstroms, Inc. (USA).

Example polymers that can be used include thermoplastics such as polarity-modified polyethylenes and/or polarity-modified polypropylenes, which can be defined as polyethylenes and/or polypropylenes copolymerized or otherwise modified with additives or components to raise the surface tension of the polymer to within the surface energy ranges set forth above. In one example, if polar components are added or copolymerized with other monomers to form a thermoplastic polymer or copolymer with high polarity, then components ranging from 4 dyne/cm to 10 dyne/cm can be added. Example polarity-enhancing additives or components that can be used include polyurethanes, polyamides, polyethersulfones, etc. The polymer or copolymer adhesion layer can be adhesive or otherwise suitable to receive and stick well to latex particles and/or pigment colorant that may be present in an imaging ink composition, for example. The adhesion layer can further include additives to provide any of a variety of enhancements or functionalities, e.g., 1-10 wt % processing aids or processing aid packages, anti-oxidant, viscosity modifiers, slip components, additives to increase polarity (including copolymerized or separately included additives thereof), etc. For example, processing aids can be used to enhance flow properties for polymer co-extrusion, and in other examples, anti-oxidants can be added to assist with reducing storage cracking from ozone-induced oxidation that may occur with some polymers, e.g., some but not all polarity-modified polypropylene polymers. Thus, in one example, the adhesion layer can include from 0.5 wt % to 3 wt % or from 1 wt % to 2 wt % % anti-oxidant, e.g., Techmer™ PM Antioxidant 111772 (polyethylene-based master batch of primary and secondary antioxidants, or Irgafos™ 168 (Tris(2,4-di-tert-butylhexyl)phosphite. In another example, the adhesion layer can include from 0.5 wt % to 3 wt % or 1 wt % to 2 wt % processing aid, e.g., Techmer™ PM 111684 (perfluoropolypropylene polymer master batch). These additives are available from TechmerPM (USA).

With further regard to the transfer film 120 of the transfer medium 100, the durability layer 126 can be defined as a layer that is joined or fused with the adhesion layer 122 at a film interface 124. The film interface can be a clean junction where the two layers are joined together but do not become composited as blended polymer that is detectable, or alternatively, the film interface can be in the form of a composited interface having a thickness where the two layers are blended together, such as may occur when both layers are simultaneously applied by a hot co-extrusion, for example. If a composited interface is present, it can typically be thinner than individually either the durability layer or the adhesion layer. Thus, an inner surface of the durability layer can be joined (often by co-extrusion) with an outer surface of the adhesion layer. Whether the film interface is composited or not, these two layers can be formulated to have a Melt Mass-Flow Rate (MFR) greater than about 8 grams per 10 minutes, or greater than about 12 grams per 10 minutes, or greater than about 15 grams per 10 minutes, measured at 230° C. under 2.16 kg pressure, for example.

In further detail regarding the durability layer 126, polypropylene-ethylene polymers can lack abrasion resistance, including those modified with polar groups. As textile printing has the added challenge of undergoing frequent machine-washing, there can be a constant cycle of abrasion-inducing events, e.g., washing and drying in between uses for clothing. However, polymers that may otherwise be abrasion resistant if applied incorrectly, may not provide desirable drape and/or hand properties. For example, abrasion resistant polymers polyurethane and polyester can perform well in washfastness testing, but in some instances, they can be detrimental to drape performance. By preparing a multi-layered transfer film which combines the printability of an adhesion layer (that may provide better drape and hand properties) combined with a more durable, but thick coat of a protective polymer, a good balance between durability, drape, and hand can be achieved. In furtherance of this, the durability layer can have higher or increased mechanical properties relative to the adhesion layer. For example, the durability layer can have a Rockwell hardness from 50 to 110, from 60 to 100, or from 70 to 100, for example, using the HR-A scale.

“Rockwell hardness” provides measurable values based on indentation hardness of a material. Indentation hardness can be measured by the depth of penetration of an indenter under a “major load” compared to the penetration made by a fixed “minor load.” In accordance with the values provided herein for Rockwell hardness, the HR-A scale is applicable which utilizes a diamond cone (120 deg) with a fixed minor load 10 kg and a major load of 60 kg.

In one example, the durability layer can be thinner than the adhesion layer and can protect the image printed on the adhesion layer. The durability layer can be a polymer, copolymer, or blend thereof which includes a thermoplastic material, such as a thermoplastic polyurethane (TPU), polyamide (PA or Nylon), polyethersulfone (PES), etc. The durability layer can further include additives to provide any of a variety of enhancements or functionalities, e.g., 1-10 wt % processing aids or processing aid packages, anti-oxidant, viscosity modifiers, slip components, additives to increase polarity (including copolymerized or separately included additives thereof), etc. For example, processing aids can be used to enhance flow properties for polymer co-extrusion. In one example, the durability layer can include from 0.5 wt % to 3 wt % or from 1 wt % to 2 wt % % processing aid, e.g., Techmer PM 111684 (perfluoropolypropylene polymer master batch).

Turning now to the removable liner 130 in FIG. 1, this portion of the transfer medium 100 can be included for purposes of application of the transfer film 120, but is then to be removed after transfer film application. The removable liner can be defined herein to include multiple layers, namely a base layer 136, a deformable layer 134, and a silicone release layer 132. The base layer can be defined as a layer that provides a substrate for the other layers, but also provides structure to assist with forcing the transfer film into pores of a fabric substrate (as illustrated by example hereinafter in FIGS. 3A-3C). The base line can be any support structure sufficient for carrying out these functions. However, in one example, the base layer can include a base paper, which can be inexpensive and yet still effective. The base paper can be raw base paper, coated base paper, treated base paper, etc. In further detail, the deformable layer can be defined herein to as a layer or coating present on one or both sides of the base layer, but in one example, is included on an inner surface of the base layer. In one example, the base substrate is the thickest of the layers of the transfer medium, but regardless, can range from 50 μm to 300 μm or from 100 μm to 200 μm in thickness, for example.

The deformable layer 134, on the other hand, can be a relatively thin layer of polymer, and can include for example a polyurethane or a polyalkylene (such as polyethylene or polypropylene). The thickness of this layer can be from 10 μm to 100 μm or from 20 μm to 50 μm. Notably, there may be a deformable layer applied to both sides of the base layer, as shown in FIG. 4 by way of example, and both layers, if present, can be included within these ranges in certain examples. These thickness ranges can be applicable to the deformable layer(s) applied to the inner surface of the base layer 136, and in some instances, also to the outer surface of the base layer (not shown, but exemplified in the example section). This layer can be softenable under transfer medium application temperatures and pressures, e.g., temperature from 175° C. to 205° C. or from 185° C. to 195° C. with pressure from 20 psi to 90 psi or from 20 psi to 60 psi. The “application temperature” and “application pressure” can be defined as the temperature(s) and pressure(s) at which the transfer medium is used to apply a printed image along with a transfer film to a fabric substrate. In one example, the application temperature(s), for example, can include a maximum temperature (Tₘₐₓ) within the application temperature range or temperature ramp used to apply the transfer film, and thus, softening points of the various polymers described herein can be defined relative to Tₘₐₓ. In one example, the softening point of the deformable layer can be less than the maximum application temperature (Tₘₐₓ) of the press device, e.g., clamshell press, used to apply the transfer film to the fabric substrate. In another example, the softening point of the deformable layer can be within about 75° C. of Tₘₐₓ (or within about 25° C. or within about 20° C. of Tₘₐₓ) applied to the transfer medium during application. In another example, the softening point of the deformable layer can be 160° C. to 200° C. In accordance with certain examples, as the base layer provides structure to the removable liner in a direction perpendicular to its inner and outer surfaces, this structure can act to provide a backing to push (under heat and pressure) the softened deformable layer fluidly toward the transfer film 120, even as the silicone release layer 132 is positioned therebetween.

The silicone release layer 132 can be the layer that is releasably associated with an outer surface of the transfer film 120, and more specifically, an outer surface of the durability layer 126. The term “silicone” refers to a group of inert, synthetic polymeric organosilicon compounds which include repeating siloxane units. Upon application of heat and pressure, the base layer 136 and the deformable layer 134 work in tandem to push the transfer film into the fabric substrate 140, as shown in FIG. 5B. The silicone release layer can also be soft and compliant enough under heat to also be deformed and pushed (indirectly) into the pores of the fabric substrate. As a result, in some examples, when the removable liner 130 is separated from the transfer film, as shown in FIG. 5C, an embossing effect may visibly remain on the silicone release layer, indicating its conformability in being pushed along with the transfer film into the fabric pores by the base layer and the deformable layer. As can be seen in FIG. 5C, the silicone release layer is shown as retaining some of the shape of the transfer film to which it was previously in contact with during the fusion process (e.g., heat, pressure, and time). In further detail, the silicone release layer can have a thickness from 0.5 μm to 15 μm or from 1 μm to 5 μm, for example, as it can be formulated to be thin enough to not absorb or otherwise dissipate the fluid force provided by the softened deformable layer and the base layer. In other words, the silicone release layer can have multiple purposes, including transferring pushing forces provided by the base layer structure and the softened deformable layer (under external pressure) into the transfer film, and providing the ability of the removable liner to be separated from the transfer film after application to a fabric substrate. In one example, the silicone release layer can include a material such as polydimethylsiloxane (PDMS), or other similar silicone release layer silicone or silicone rubber materials. In further detail, as with the deformable layer, in one example, the softening point of the silicone release layer can be less than the maximum application temperature of the press device, e.g., clamshell press, used to apply the transfer film to the fabric substrate. For example, this layer can also be softenable under transfer medium application temperatures and pressures, e.g., temperature from 175° C. to 205° C. or from 185° C. to 195° C. with pressure from 20 psi to 90 psi or from 20 psi to 60 psi.

Thus, there are several properties related to image transfer to fabrics that can be achieved in accordance with the present disclosure. In one example, the transfer medium can exhibit good ink composition adhesion, and in one example, good latex ink composition adhesion. Once the ink composition is printed on the adhesion layer of the transfer medium, the adhesion layer and the protection layer can stay with the fabric after fusion therewith followed by separating therefrom the removable liner. Thus, good image quality (e.g., ink adhesion, color gamut, edge acuity, etc.), can be achieved because the image is applied to an adhesion layer that may be formulated for receiving a (reverse or mirror-image) printed ink composition, which can contribute to a higher quality printed image than may normally be achievable when printing directly on a fabric substrate. The image can be printed in reverse or as a mirror image because the viewable side of the image can be through the transfer film, which can be transparent or translucent, for example. Furthermore, because the transfer film remains with the printed image (with the printed image positioned between the transfer film and the fabric), the transfer film can help to protect the image from damage, including abrasion damage and/or other types of damage that may otherwise occur when machine washing the fabric. This is sometimes referred to as “washfastness,” which can be defined as the ability of a printed fabric to resist image quality reduction that can occur during normal washing cycles. In still additional detail, due to the construction of the transfer medium as a whole described herein, images with a level of gloss that can approximate the appearance of fabric substrate to which it is applied can be realized, including matte images applied to fabrics that may have a matte appearance to the fabric surface, e.g., cotton, polyester, or cotton/polyester blend fabrics often used for T-shirts. This can be because the transfer film with the image printed thereon can be pushed more thoroughly into the voids present on a surface of the fabric, in part due to the transfer film materials and thickness, but also because the removable liner construction acts to more thoroughly push the transfer film into the fabric pores.

In addition to image quality and washfastness durability, other properties that can be achieved include retention of acceptable hand and drape properties (compared to unprinted portions of the fabric substrate. “Hand” refers to the overall feel of the fabric against the skin. The term “hand” can be used to describe the fabric substrate as well as the printed fabric. If the printed areas are similar in feel (but perhaps not identical), it can be said to have good hand properties. Words often used to describe hand include cool, slick, smooth, loose, stiff, heavy, stretchy, etc. In examples of the present disclosure, some hand can be sacrificed (compared to unprinted fabric) in exchange for some durability, but the hand properties can still be acceptable to a user who may be in dose skin contact with the fabric. The term “drape” can refer to how a fabric bends and/or hangs, etc., and different fabrics have different drape properties. In accordance with some examples of the present disclosure, printed images (with the transfer film therewith) applied to fabrics can have hand and drape properties that are acceptable to most users, e.g., 9 out of 10 users. In further detail, in one example, a portion of the fabric with the printed image applied thereto can exhibit similar drape and hand properties (often nominally or minimally diminished in some examples) compared to unprinted fabric portions as indicated by 9 out of 10 users, for example.

In one specific example, to obtain a more balanced combination of acceptable hand and drape on a fabric compared to durability, such as with a cotton or cotton/polyester blend T-shirt, a transfer film having a total thickness of 10 μm to 50 μm (about 0.5 mil to about 2 mils) can be used, e.g., 7.5 μm to 40 μm adhesion layer and 5 μm to 15 μm durability layer. At greater thicknesses, additional durability can be achieved but may be traded for a diminishment in hand and/or drape properties. Reducing some durability in exchange for improved hand and/or drape properties can occur with thinner transfer films. Generally, drape is quite good at about 51 μm or less, though thicker transfer films can provide acceptable drape properties as well.

With more general reference to the various textile printing systems and methods herein, the textile printing systems can be imaged using any imaging technique available. However, in one example, ink compositions can be inkjetted on the adhesion layer using thermal, piezo, or other inkjet technologies. In one example, the ink composition can be an aqueous ink composition, and in further detail, can be a latex-containing ink composition. The colorant can be a dye or pigment, but in one example, colorant can be a pigment that is either self-dispersed or is dispersed by a separate polymer.

In one example, the colorant can be a pigment of any of a number of primary or secondary colors, or can be black or white, for example. More specifically, colors can include cyan, magenta, yellow, red, blue, violet, red, orange, green, etc. In one example, the ink composition can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, PO48, PO49, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., Pigment Yellow 74 and Pigment Yellow 155.

As mentioned, the pigment can be self-dispersed by a small molecule, oligomer, or polymer having the dispersing agent covalently attached to a surface thereof. For example, commercially available surface-modified pigments sold under the tradename CaboJet®, from Cabot Corporation (USA), can be used. Alternatively, the pigment can be dispersed by a separate dispersant, such as a styrene acrylate or methacrylate dispersant, or another dispersant suitable for keeping the pigment suspended in the liquid vehicle. In one example, the styrene-acrylic dispersant can have a weight average molecular weight from 4,000 Mw to 30,000 Mw. In another example, the styrene-acrylic dispersant can have a weight average molecular weight of 8,000 Mw to 28,000 Mw, from 12,000 Mw to 25,000 Mw, from 15,000 Mw to 25,000 Mw, from 15,000 Mw to 20,000 Mw, or about 17,000 Mw. Regarding the acid number, the styrene-acrylic dispersant can have an acid number from 100 to 350, from 120 to 350, from 150 to 300, from 180 to 250, or about 214, for example. The term “acid value” or “acid number” refers to the mass of potassium hydroxide (KOH) in milligrams that can be used to neutralize one gram of substance (mg KOH/g), such as the latex polymers disclosed herein. This value can be determined, in one example, by dissolving or dispersing a known quantity of a material in organic solvent and then titrating with a solution of potassium hydroxide (KOH) of known concentration for measurement. Example commercially available styrene-acrylic dispersants can include Joncryl® 671, Joncryl® 71, Joncryl® 96, Joncryl® 680, Joncryl® 683, Joncryl® 678, Joncryl® 690, Joncryl® 296, Joncryl® 671, Joncryl® 696 or Joncryl® ECO 675 (all available from BASF Corp., Germany).

In further detail, the ink compositions can also include a dispersed polymer, which generally refers to any dispersed latex polymer or other resins that are dispersed within the ink composition. Example dispersed polymers can include latex polymer, polyurethane dispersed polymer, etc., and others. In further detail, the weight average molecular weight of the dispersed polymer can be from 20,000 Mw to 500,000 Mw. In other examples, the weight average molecular weight can be from 50,000 Mw to 500,000 Mw, from 100,000 Mw to 400,000 Mw, or from 150,000 Mw to 300,000 Mw. The acid number of the dispersed polymer can be from 2 mg KOH/g to 200 mg KOH/g, from 5 mg KOH/g to 100 mg KOH/g, or from 20 mg KOH/g to 50 mg KOH/g, for example. The dispersed polymer can have an average particle size ranging from 20 nm to 500 nm, from 50 nm to 350 nm, or from 150 nm to 300 nm. The particle size of any solids herein, including the average particle size of the dispersed polymer, can be determined using a Nanotrac® Wave device, from Microtrac, which measures particle size using dynamic light scattering. Average particle size can be determined using particle size distribution data generated by the Nanotrac® Wave device.

As mentioned, the dispersed polymer binder can be a latex polymer prepared from acrylate (or acrylic acid) monomers, methacrylate (or methacrylic acid) monomers, styrene, modified-styrene such as phenoxylalkyl (meth)acrylates or others, or any of a number of other monomers. The term “alkyl” or “aliphatic” or the like refers to methyl, ethyl, or branched or unbranched saturated carbon chains from C2 to C10, for example. In further detail, the latex polymer can include copolymerized lower alkyl (C1-C5) modified-acrylates (linear or branched); copolymerized alicyclic acrylates and/or methacrylates; copolymerized aromatic acrylates and/or methacrylates, etc. Examples include ethyl acrylate, ethyl methacrylate, benzyl acrylate, benzyl methacrylate, propyl acrylate, propyl methacrylate, isopropyl acrylate, isopropyl methacrylate, butyl acrylate, butyl methacrylate, isobutyl acrylate, isobutyl methacrylate, hexyl acrylate, hexyl methacrylate, isooctyl acrylate, isooctyl methacrylate, octadecyl acrylate, octadecyl methacrylate, lauryl acrylate, lauryl methacrylate, hydroxyethyl acrylate, hydroxyethyl methacrylate, hydroxyhexyl acrylate, hydroxyhexyl methacrylate, hydroxyoctadecyl acrylate, hydroxyoctadecyl methacrylate, hydroxylauryl methacrylate, hydroxylauryl acrylate, 2-ethylhexyl acrylate, 2-ethylhexyl methacrylate, or combinations thereof. Examples of the cycloaliphatic acrylate and/or methacrylate monomers (including salts) can include cyclohexyl acrylate, cyclohexyl methacrylate, methylcyclohexyl acrylate, methylcyclohexyl methacrylate, trimethylcyclohexyl acrylate, trimethylcyclohexyl methacrylate, tert-butylcyclohexyl acrylate, tert-butylcyclohexyl methacrylate, and combinations thereof. In further examples, cycloaliphatic monomer can include cyclohexyl acrylate, cyclohexyl methacrylate, methylcyclohexyl acrylate, methylcyclohexyl methacrylate, trimethylcyclohexyl acrylate, trimethylcyclohexyl methacrylate, tert-butylcyclohexyl acrylate, tert-butylcyclohexyl methacrylate, or a combination thereof. In still further examples, certain aromatic (meth)acrylate monomers that can be used include 2-phenoxylethyl methacrylate, 2-phenoxylethyl acrylate, phenyl propyl methacrylate, phenyl propyl acrylate, benzyl methacrylate, benzyl acrylate, phenylethyl methacrylate, phenylethyl acrylate, benzhydryl methacrylate, benzhydryl acrylate, 2-hydroxy-3-phenoxypropyl acrylate, 2-hydroxy-3-phenoxypropyl methacrylate, N-benzyl methacrylamide, N-benzyl acrylamide, N,N-diphenyl methacrylamide, N,N-diphenyl acrylamide, naphthyl methacrylate, naphthyl acrylate, phenyl methacrylate, phenyl acrylate, or a combination thereof.

In some examples, the latex particles can include a single heteropolymer that is homogenously copolymerized or can include a first heteropolymer phase and a second heteropolymer phase. The two phases can be composited together, included as separate latex particles, in a core-shell configuration, a two-hemisphere configuration, smaller spheres of one phase distributed in a larger sphere of the other phase, interlocking intermingled strands of the two phases, and so on. The second heteropolymer phase can have a higher T_{g} than the first heteropolymer phase. The first heteropolymer composition may be considered a soft polymer composition and the second heteropolymer composition may be considered a hard polymer composition. In further detail, the first heteropolymer composition can be present in the latex polymer in an amount ranging from about 15 wt % to about 70 wt % of a total weight of the polymer particle, and the second heteropolymer composition can be present in an amount ranging from about 30 wt % to about 85 wt % of the total weight of the polymer particle. In other examples, the first heteropolymer composition can be present in an amount ranging from about 30 wt % to about 50 wt % of a total weight of the polymer particle, and the second heteropolymer composition can be present in an amount ranging from about 50 wt % to about 70 wt % of the total weight of the polymer particle.

The ink compositions of the present disclosure can be formulated to include an aqueous liquid vehicle, which can include the water content, e.g., 60 wt % to 90 wt % or from 75 wt % to 85 wt %, as well as organic co-solvent, e.g., from 4 wt % to 30 wt %, from 6 wt % to 20 wt %, or from 8 wt % to 15 wt %. Other liquid vehicle components can also be included, such as surfactant, antibacterial agent, other colorant, etc. However, as part of the ink composition, pigment, dispersant, and the latex polymer can be included or carried by the liquid vehicle components.

In further detail regarding the aqueous liquid vehicle, co-solvent(s) can be present and can include any co-solvent or combination of co-solvents that is compatible with the pigment, dispersant, and polymer latex. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, dimethyl sulfoxide, sulfolane, glycol ethers, alkyldiols such as 1,2-hexanediol, and/or ethoxylated glycerols such as LEG-1, etc.

The aqueous liquid vehicle can also include surfactant. In general, the surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a Surfynol® surfactant, e.g., Surfynol® 440 (from Evonik, Germany), or a Tergitol™ surfactant, e.g., Tergitol™ TMN-6 (from Dow Chemical, USA). In another example, the surfactant can include an anionic surfactant, such as a phosphate ester of a C10 to C20 alcohol or a polyethylene glycol (3) oleyl mono/di phosphate, e.g., Crodafos® N3A (from Croda International PLC, United Kingdom). The surfactant or combinations of surfactants, if present, can be included in the ink composition at from about 0.01 wt % to about 5 wt % and, in some examples, can be present at from about 0.05 wt % to about 3 wt % of the ink compositions.

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticide®, e.g., Acticide® B20 (Thor Specialties Inc.), Nuosept™ (Nudex, Inc.), Ucarcide™ (Union carbide Corp.), Vancide® (R.T. Vanderbilt Co.), Proxel™ (ICI America), and combinations thereof. Sequestering agents, such as EDTA (ethylene diamine tetra acetic acid) or trisodium salt of methylglycinediacetic acid, may be included to eliminate the deleterious effects of heavy metal impurities, and buffer solutions may be used to control the pH of the ink. Viscosity modifiers and buffers may also be present, as well as other additives modify properties of the ink as desired.

Turning now to the fabric substrate, though the transfer media described herein can be used on any type of fabric, it is particularly useful when applying images to fabric substrates that have a more matte appearance, e.g., where added gloss generated by films that are not sufficiently pushed into the pores of the fabric leave an undesirable and noticeable glossy sheen. In one example, fabric often used for t-shirts, such as cotton, polyester, and cotton/polyester blends can provide good results. To illustrate, rather than using the removable liner described in the present disclosure, if a paper substrate is used without the same coatings, release from the transfer film may be difficult. Likewise, even when using some other types of removable liner coatings or layers applied to paper that may be otherwise suitable for providing good release or other mechanical properties, e.g., clay coatings, these types of material do not soften at application temperatures (or even at Tₘₐₓ). Thus, even though the silicone release layer may become softened, a clay coating attached to an outer surface of the release liner does not act to adequately push the transfer film into the pores, thus causing the transfer film to retain unwanted gloss, e.g., the transfer film tends to sit on top of the fabric retaining a more flattened shape, e.g., not conforming to the fabric surface pores as well. A flat transfer film on a matte fabric substrate tends to have a glossy appearance that is noticeable relative to the matte fabric background. In other words, with other types of materials, such as clay coated papers, though they release well, they do not tend to push the transfer film into the fabric sufficient to reduce gloss to a desirable level. Transfer films applied with clay coated paper tend to be glossier, and tend to have less desirable drape and hand qualities.

Though T-shirts have been mentioned as good fabric substrate material for use with the transfer media described herein, there are a variety of fabric substrates that can be used. For example, the fabric substrate can be in one of many different forms, including a textile, a cloth, a fabric material, fabric clothing, or other fabric product suitable for applying ink, and the fabric substrate can have any of a number of fabric structures. The term “fabric structure” includes structures that can have warp and weft, and/or can be woven, non-woven, knitted, tufted, crocheted, knotted, and pressured, for example. The terms “warp” and “weft” have their ordinary meaning in the textile arts, as used herein, e.g., warp refers to lengthwise or longitudinal yarns on a loom, while weft refers to crosswise or transverse yarns on a loom. It is also notable that the term “fabric substrate” or “fabric media substrate” does not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into finished articles (e.g. clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include but is not limited to, fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of multiple processes.

As previously mentioned, the fabric substrate can be a combination of fiber types, e.g. a combination of natural fiber with another natural fiber, natural fiber with a synthetic fiber, a synthetic fiber with another synthetic fiber, or mixtures of multiple types of natural fibers and/or synthetic fibers in any of the above combinations. In some examples, the fabric substrate can include natural fiber and synthetic fiber, e.g., cotton/polyester blend. The amount of each fiber type can vary. For example, the amount of the natural fiber can vary from about 5 wt % to about 94.5 and the amount of synthetic fiber can range from about 5 wt % to 94.5. In yet another example, the amount of the natural fiber can vary from about 10 wt % to 80 wt % and the synthetic fiber can be present from about 20 wt % to about 90 wt %. In other examples, the amount of the natural fiber can be about 10 wt % to 90 wt % and the amount of synthetic fiber can also be about 10 wt % to about 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

In one example, the fabric substrate can have a basis weight ranging from about 10 gsm to about 500 gsm. In another example, the fabric substrate can have a basis weight ranging from about 50 gsm to about 400 gsm. In other examples, the fabric substrate can have a basis weight ranging from about 100 gsm to about 300 gsm, from about 75 gsm to about 250 gsm, from about 125 gsm to about 300 gsm, or from about 150 gsm to about 350 gsm.

In addition, the fabric substrate can contain additives including, but not limited to, colorant (e.g., pigments, dyes, and tints), antistatic agents, brightening agents, nucleating agents, antioxidants, UV stabilizers, and/or fillers and lubricants, for example. Alternatively, the fabric substrate may be pre-treated in a solution containing the substances listed above before applying other treatments or coating layers.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and can be determined based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is only an example or illustrative of the application of the principles of the presented formulations and methods. Numerous modifications and alternative methods may be devised without departing from the present disclosure. The appended claims are intended to cover such modifications and arrangements. Thus, while the technology has been described above with particularity, the following provides further detail in connection with what are presently deemed to be the acceptable examples.

### Example 1—Evaluation Removable Liners

A two-layered transfer film as described herein was prepared with several different types of removable liners. The first removable liner prepared included a paper layer (no silicone release layer). The second removable liner included a paper base liner coated with clay on one side and a silicone (PDMS) release layer on the other. The third removable liner included a paper base layer and a polymeric (polyethylene) deformable layer to both paper surfaces and further included a PDMS release layer coated thereon on one side, as shown in FIG. 4. The construction of the three liners is shown by way of example in Table 1, as follows:

TABLE 1
Liner Construction

| | | | | | Coefficient of |
|---|---|---|---|---|---|
| | | Secondary | Silicone | Gloss | friction front/back |
| Liner | Base | Layer(s) | Release | at | (measured across |
| ID | Layer | (thickness) | Layer | 75° | print direction) |
| 1* | Cellulose | N/A | N/A | — | — |
| 2** | Cellulose | Clay | PDMS | 78.2 | 0.45/0.62 |
| | | Single (outer) | | | |
| | | surface of | | | |
| | | Base Layer | | | |
| | | Coated at 105 μm | | | |
| 3*** | Cellulose | Polyethylene | PDMS | 73.2 | 0.22/0.54 |
| | | Both | | | |
| | | Surfaces of | | | |
| | | Base Layer | | | |
| | | Coated at 175 μm | | | |

*The first liner in Table 1 was not removable.
**Liner 2 had a glossy appearance prior to fabric application (outermost surface).
***Liner 3 had a glossy appearance prior to fabric application (outermost surface); furthermore, the secondary layers of the third liner can be considered a deformable layer in accordance with examples of the present disclosure, because unlike the clay, the polyethylene layer is softenable or meltable under application heat and pressure.

All three were used to apply to a cotton T-shirt using a clamshell heat press set at about 190° C. and 4 bar (60 psi) for 30 seconds. The first transfer medium prepared with the paper liner would not release from the transfer film after application. The second removable liner, which was the clay coated liner (with PDMS release liner) released adequately, but the drape and hand properties were undesirable, having a plastic-like feel. The third removable liner prepared in accordance with examples of the present disclosure conformed more closely with the texture of the fabric and provided matte finish with acceptable drape and hand properties.

To understand the difference between the second and the third removable liner (even though the transfer film applied was identical and the processing conditions were identical), both transfer films after transfer to the porous fabric were imaged using a scanning electron microscope (SEM) to generate multiple micrographs of the transfer films on the fabric substrates. A top SEM view of the transfer film applied using the removable liner with a clay intermediate layer (rather than PE) showed that the film remained largely on top of the fabric with only minimal transfer film penetration into the pores of the fabric, thus providing a glossy appearance, poor drape properties, and plastic-like feel. Conversely, a top SEM view of the transfer film applied using the removable liner with a polyethylene deformable layer (polyethylene) showed that the film was pushed significantly into the pores of the fabric, taking on a very similar profile relative to the fabric surface, thus providing a matte appearance, good drape properties and hand. Thus, the removable liner design, which does not even remain with the transfer film and printed image, can provide a positive difference in appearance. Thus, in the heat press (190° C. in this example), as the polyethylene deformable layer softens or even melts, typically at from 120° C. to 180° C. (and as low as 105° C. for LDPE), flowing under pressure towards the macrostructure of the fabric, the softened and/or melting (or melted) polymer pushes against (indirectly through the silicone release layer) the transfer film that also softens to coat the fabric surface, including within pores thereof. The silicone release layer keeps the polyethylene and the transfer film mixing, and also provides a surface that can be mechanically released from the transfer film, even though it may now be no longer flat and conformed to a profile shape of the fabric surface.

After application of the transfer film to the fabric substrate, the silicone release layer of the clay coated paper and the polyethylene coated paper was inspected. The clay-based removable liner exhibited an essentially flat (with a few bumps) silicone release layer, whereas the silicone layer on the polyethylene-based removable liner retained an embossed imprint, such as that shown by example schematically in FIG. 5C. The “embossing” pattern that remained on the silicone release layer was a negative imprint of the same pattern observed on the transfer film-coated fabric, and thus the fabric itself. The same removable liner was reused 10 times, and each time the shape of the silicone release layer conformed to the general porosity of the fabric substrate, at which time the experiment was stopped.

### Example 2—Evaluation of Adhesion Layers of Transfer Film

Three different adhesion layers were prepared for comparison. The adhesion layer is the layer that can be used to receive a reverse image printed thereon, such as a latex ink-generated image, for application to a fabric substrate. To test their ink adhesion properties relative to a latex-based inkjet ink, these various adhesion layers were extruded on a removable liner, such as shown and described in FIGS. 1 and 3-5C, for example, which included a paper base layer, a polyethylene deformable layer, and a PDMS release layer. The first ink application layer prepared is identified as the Control Layer in Table 2 below, which is a commercial product with the tradename Versify® 4200, from Dow Chemical (USA) (no polar additives). The second and third adhesion layers prepared are provided in Table 2 below and are identified as Adhesion Layer 1 and Adhesion Layer 2, for example. Adhesion Layer 1 was similar to the Versify® 4200 Control Layer, but with added polar groups; and Adhesion Layer 2 included a polymer that was evaluated as having a polarity and surface energy that was considerably higher than the Versify® 4200 product, e.g., with similar levels to that of Adhesion Layer 1.

TABLE 2
Adhesion Layer Formulations

| | Control | Adhesion | Adhesion |
|---|---|---|---|
| | Layer | Layer 1 | Layer 2 |
| | (parts by | (parts by | (parts by |
| Ingredient | weight) | weight) | weight) |
| Versify ® 4200 | 100 | 100 | — |
| Propylene-ethylene | | | |
| thermoplastic (non-polar) | | | |
| Elvaloy ® 741 | — | 10 | — |
| Ethylene/vinyl acetate/ | | | |
| carbon monoxide | | | |
| copolymer (polar | | | |
| component) | | | |
| Techmer ™ PPM111684 | — | 3 | 3 |
| Extrusion Processing Aid | | | |
| Techmer ™ PM 111772 | — | 1.5 | 1.5 |
| Antioxidant | | | |
| Orevac ® 9304 | — | — | 100 |
| Ethylene vinyl acetate | | | |
| copolymer (with polar | | | |
| groups) | | | |
| Total Surface Energy | 35.7 | 46.2 | 50 |
| | dynes/cm | dynes/cm | dynes/cm |
| Polar Component | — | 6.68 | 6.18 |
| Surface Energy (s-) | | dynes/cm | dynes/cm |

Versify ® and Elvaloy ® are from Dow Chemical, USA.
Techmer ™ additives are available from TechmerPM Polymer Modifiers (USA).
Orevac ® is available from Arkema Innovative Chemistry (France).

In accordance with Table 2, surface energy measurements of the extruded ink adhesion films evaluated indicated that higher polymer polarity corresponded with higher surface free energy, and the polar component (s-), which is equal to zero for the control (non-polar), had a higher value for the more polar polymers. With this information, the three extruded layers (Control Layer, Adhesion Layer 1, and Adhesion Layer 2) were used to determine whether the surface energy measurements would correlate to latex ink adhesion. To conduct the study, a tape test was carried out using four (4) different types of tapes with different adhesive strengths, 2.2 N/m², 3.3 N/m², 11.5 N/m², 16.8 N/m². Essentially, a latex-based pigmented inkjet ink was printed in sample blocks at 600 dpi on the various layers and the ink was allowed to dry. After leaving the tape in place for 30 minutes, the weakest tape (2.2 N/m²) was enough to cause the Control Layer to fail, with the latex-ink being stripped from the Control Layer throughout (leaving large white areas behind where the ink was removed). Adhesion Layers 1 and 2 both passed the tape test at 2.2 N/m² as well as at 3.3 N/m². Adhesion Layer 1 then failed using the third strongest tape (11.9 N/m²), whereas Adhesion Layer 2 passed even the strongest adhesive tape (16.8 N/m²) test, with the tape leaving the printed image intact on Adhesion Layer 2. As Adhesion Layer 2 had the highest polarity, with a surface energy of 50 dynes/cm, and as Adhesion Layer 2 performed the best, there appears to be a correlation between polarity and ink adhesion on adhesion layer films.

In further detail, in accordance with Table 2, the inclusion of the anti-oxidant with the polymer or copolymer with polar groups can contribute to the stability of the polymer over time, particularly with respect to polyolefins, such as polyethylene and polypropylene, for example. Under accelerated aging testing in an ozone chamber at 100 ppm for 10 hours, which was estimated to be equivalent to 3 months of ambient exposure, polymer cracking with polymer and without the anti-oxidant occurred, whereas even a small amount of anti-oxidant as shown in Table 2 provided 3 months (as tested) of life without any cracking.

### Example 3—Evaluation of Durability Layers of Transfer Film

A composition for co-extruding a durability layer with an adhesion layer was prepared to determine whether a thin coating applied to an outer surface (relative to the fabric, once applied) of the adhesion layer would provide adequate washfastness abrasion resistance, even though some of the polymers that can be used to form the adhesion layer are not known to be very abrasion resistant themselves. For this experiment, an adhesive composition was prepared using the principles described in Example 2 that can be used to form an adhesion layer with high polarity, but which of itself would not be expected to be particularly durable. This adhesive composition was co-extruded under heat (as an adhesion layer) with a durability composition used to form a durability layer. The co-extruded layers are described in Table 3, as follows:

TABLE 3
Transfer Film Formulation and Construction

| | Adhesion | Durability |
|---|---|---|
| | Layer 3 | Layer |
| | (parts by | (parts by |
| Ingredient | weight) | weight) |
| Lotader ® 3410 | 100 | |
| Ethylene/Acrylic Ester/Maleic | | |
| Anhydride Terpolymer | | |
| Orevac ® 9304 | 10 | |
| Ethylene/Vinyl Acetate Copolymer | | |
| (polar component) | | |
| Techmer ™ PPM111684 | 3 | |
| Extrusion Processing Aid | | |
| Techmer ™ PM 111772 | 1.5 | |
| Antioxidant | | |
| Aliphatic Polyester and | — | 100 |
| Polycaprolactone Thermoplastic | | |
| Polyurethane | | |
| Approx. Application Thickness | 25 μm | 12.5 μm |

Techmer ™ additives are available from TechmerPM Polymer Modifiers (USA).
Lotader ® and Orevac ® are available from Arkema Innovative Chemistry (France).

The transfer film described in Table 3, which included both Adhesive Layer 3 and a Durability Layer, was printed with multiple durability black and color durability plot squares at 3 drops per pixel 600 dpi (12 ng/drop) using a thermal inkjet printhead. The transfer film (dual-layer) was then applied using heat to a cotton fabric substrate (with the printed image between the fabric and Adhesion Layer 3). A removable liner prepared in accordance with the present disclosure, e.g., such as removable liner 3 of Table 1, was used to apply the transfer film at about 190° C. and 60 psi for about 30 seconds. Washfastness was tested using 2 washes in a standard washing machine at 40° C. to determine whether the dual-layered transfer film provided adequate washfastness resistance. Delta E (ΔE) data was collected, with a lower value being better, e.g., lower value indicates less change in color properties such as optical density (OD) or gamut, for example. The various samples were evaluated to obtain optical density (OD) and L*a*b* color space values, which represented the “pre-washing” values, or reference black or color values. Then, the printed fabric substrates were washed at 40° C. with laundry detergent (e.g., Tide® available from Proctor and Gamble, Cincinnati, Ohio, USA) for two (2) cycles, air drying the printed fabric substrates between each washing cycle. After the two cycles, optical density (OD) and L*a*b* values were measured for comparison. The delta E (ΔE) values were calculated using the 1976 standard denoted as ΔE_{CIE} as well as the 2000 standard denoted as ΔE₂₀₀₀. For comparison, Adhesion Layer 1 from Table 2 of Example 2 was also tested using the same protocol, except that Adhesion Layer 1 did not include a durability layer. ΔE for the dual-layer transfer film with both Adhesion Layer 3 and the Durability Layer as shown in Table 3 was 1.2, indicating minimal OD loss and/or color shift, whereas Adhesion Layer 1, when washed without a durability layer, exhibited a ΔE value of 3.6, which is not as favorable.

### Example 4—Color Gamut and Optical Density Comparative

Three different commercial products used to print on fabric were evaluated for color properties, namely Color Gamut (72 Durability Plots) and KOD (Black Optical Density). Color plots from the various systems were applied to fabric as instructed and OD and gamut values were collected. The results are provided in Table 4, where “DTG” refers to “Direct to Garment” printing and “Transfer” refers to printing on an intermediate media sheet and then transferring the image to the fabric substrate along with the intermediate transfer sheet.

TABLE 4
Color Gamut and KOD Comparison

| | Epson | Jet Pro | TechniPrint | |
|---|---|---|---|---|
| Color or | F2000 | Softstretch | Print EZP | |
| Black Value | (DTG) | (Transfer) | (transfer) | |
| Color Gamut | 126910 | 220389 | 189930 | 675883 |
| KOD | 1.2 | 1.05 | 0.93 | 2.12 |

### Example 5—Gloss Comparative

In evaluating various printed transfer films, the dual-layer transfer film prepared in accordance with Example 3 (Table 3) and applied to a white cotton T-shirt using Liner 3 of Example 1 (Table 1). Application values were 190° C., 60 psi, and 30 seconds. A gloss value of 3 was measured at the transfer film applied to the T-shirt at a 75°, which is matte in appearance. Conversely, applying the same dual-layer transfer film using a clay-based removable liner, such as Liner 2 shown in Example 1, had a much glossier appearance of 30, which is very noticeable compared to the “gloss” (or lack of gloss) that is typical of a cotton T-shirt.

While the present technology has been described with reference to certain examples, various modifications, changes, omissions, and substitutions can be made without departing from the spirit of the disclosure. It is intended, therefore, that the disclosure be limited only by the scope of the following claims.

What is claimed is:

1. A transfer medium, comprising:
a transfer film, comprising an adhesion layer and a protection layer attached to the adhesion layer, wherein the transfer film is transparent or translucent; and
a removable liner, comprising a base layer and silicone release layer, the removable liner further including a deformable layer positioned between the base layer and the silicone layer, wherein an inner surface of the silicone release layer is adhered to an outer surface of the protection layer.

2. The transfer medium of claim 1, wherein the adhesion layer is from 2.5 μm to 50 μm, the durability coating layer is from 1 μm to 25 μm, and wherein the durability coating layer is thinner than the adhesion layer.

3. The transfer medium of claim 1, further comprising a composited film interface along an inner surface of the protection layer and an outer surface of the adhesion layer the film interface, the composited film interface having a thickness less than a thickness of the durability coating layer.

4. The transfer medium of claim 1, wherein the adhesion layer includes a polymer, copolymer, or blend thereof having a surface energy from 35 dyne/cm to 50 dyne/cm, and wherein the durable coating layer includes a polymer, copolymer, or blend thereof having a Rockwell hardness from 50 to 110.

5. The transfer medium of claim 1, further comprising an ink composition layer on an inner surface of adhesion layer.

6. The transfer medium of claim 1, wherein the base layer includes paper, and the deformable layer is coated on both sides of the paper.

7. The transfer medium of claim 1, wherein the deformable layer has a softening point from 120° C. to 200° C., and includes polyethylene, polypropylene, polyurethane, a copolymer thereof, or a blend thereof.

8. The transfer medium of claim 1, wherein the silicone release layer is a polydimethylsiloxane.

9. A method of transferring an image to a fabric substrate, comprising:
contacting a fabric substrate with an imaged inner surface of a transfer medium, the transfer medium, including:
a transfer film, comprising an adhesion layer and a protection layer attached to the adhesion layer, wherein the transfer film is transparent or translucent, and
a removable liner, comprising a base layer and silicone release layer, the removable liner further including a deformable layer positioned between the base layer and the silicone layer, wherein an inner surface of the silicone release layer is adhered to an outer surface of the protection layer;
applying heat and pressure to the transfer medium while the imaged inner surface is in contact with the fabric substrate to fuse the transfer film to the fabric substrate; and
separating the removable liner from the transfer film after fusing.

10. The method of claim 9, wherein fusing includes applying heat at from 175° C. to 205° C. and pressure at from 20 psi to 90 psi for 10 seconds to 120 seconds.

11. The method of claim 9, wherein the deformable layer has a softening point ranging from a maximum temperature applied to the transfer medium during fusing to 75° C. less than the maximum temperature.

12. The method of claim 9, wherein fusing causes the deformable layer to soften or melt so that the base layer and the deformable layer forces the transfer film into voids of the fabric substrate using the silicone release layer as an intermediate to prevent the deformable layer from contacting the transfer film.

13. The method of claim 9, wherein the imaged inner surface is prepared by inkjetting a reverse image onto the inner surface of the adhesion layer.

14. A fabric imaging system, comprising:
a transfer medium, including:
a transfer film, comprising an adhesion layer and a protection layer attached to the adhesion layer, wherein the transfer film is transparent or translucent, and
a removable liner, comprising a base layer and silicone release layer, the removable liner further including a deformable layer positioned between the base layer and the silicone layer, wherein an inner surface of the silicone release layer is adhered to an outer surface of the protection layer; and
a fusing press to apply from 175° C. to 205° C. heat and from 20 psi to 90 psi pressure to the transfer medium when an inner surface of the adhesion layer is contacted with a fabric substrate.

15. The fabric imaging system of claim 14, further comprising an inkjet printer to apply a reverse image to the inner surface of the adhesion layer.
